(19) United States
(12) Patent Application Publication
(10) Pub. No.: US 2016/0080727 A1
(43) Pub. Date: Mar. 17, 2016

(54) DEPTH MEASUREMENT APPARATUS, IMAGING APPARATUS, AND DEPTH MEASUREMENT METHOD

(71) Applicant: CANON KABUSHIKI KAISHA, Tokyo (JP)

(72) Inventors: Satoru Komatsu, Yokohama-shi (JP); Keiichiro Ishihara, Yokohama-shi (JP)

(21) Appl. No.: 14/845,581

(22) Filed: Sep. 4, 2015

(30) Foreign Application Priority Data
Sep. 16, 2014 (JP) 2014-188101

(51) Int. Cl. H04N 13/02; H04N 5/232; G06T 7/00; H04N 5/357

(52) U.S. Cl. CPC H04N 13/0271; H04N 5/357; H04N 13/0217; H04N 5/23248; G06T 7/0069; H04N 2013/0081

(57) ABSTRACT

A depth measurement apparatus for calculating depth information on an object, using one color image, including: a selection unit adapted to select, from a plurality of color planes of the color image, at least two color planes with different image formation positions; an adjusting unit adapted to adjust a luminance difference between the selected color planes; and a calculation unit adapted to calculate the depth information using a difference in blur between the adjusted color planes.

### BACKGROUND OF THE INVENTION

1. Field of the Invention

The present invention relates to a depth measurement apparatus, and in particular, to a technique for measuring a depth to an object from one color image.

2. Description of the Related Art

As a technique for acquiring the depth (distance) of an imaged scene from an image taken by an imaging apparatus, depth from defocus (DFD) as described in Patent Literature (PTL) 1 has been proposed. In the DFD, image taking parameters for an imaging optical system are controlled to acquire a plurality of images with different blurs, and the magnitudes and correlation amounts of the blurs are calculated using measurement target pixels and surrounding pixels in the plurality of images acquired. The magnitude and correlation amount of the blur vary according to the depth of the object in the image, and thus, this relation is used to calculate the depth. Depth measurement based on the DFD allows the depth to be calculated using one imaging system and can thus advantageously be incorporated into commercially available imaging apparatuses.

However, misalignment may occur among the plurality of images due to camera shake or motion of the object, reducing the depth measurement accuracy of the DFD. Thus, to deal with the misalignment, PTL 1 describes alignment between images.

Furthermore, in order to avoid misalignment and the need for alignment, calculation of a depth from one image has been proposed in Non-Patent Literature (NPL) 1. More specifically, NPL 1 discloses a method of acquiring one image using an optical system in which axial chromatic aberration are intentionally caused to occur and calculating a depth utilizing a difference in image formation position associated with a wavelength.

### CITATION LIST

### Patent Literature

PTL 1: Japanese Patent Application Laid-open No. 2013-044844

### Non-Patent Literature

NPL 1: “Passive depth estimation using chromatic aberration and a depth from defocus approach”, P. Trouve, et. al., APPLIED OPTICS, October 2013

### SUMMARY OF THE INVENTION

In the DFD described in PTL 1, possible misalignment between images reduces the depth accuracy, leading to the need for accurate alignment between the images. When alignment is performed for each pixel, a calculation load for alignment processing increases, and this is problematic when real-time processing is needed as in the case of imaging apparatuses.

The technique in NPL 1 performs optimization calculation to calculate the depth and thus involves a high calculation load. Consequently, the technique has difficulty executing real-time processing. The technique also needs a memory for holding information on an optical system needed for the calculation.

With the problems as described above, it is an object of the present invention to perform quick depth measurement based on the DFD on one color image obtained by one image taking operation using easy calculations.

To accomplish the object, an aspect of the present invention provides a depth measurement apparatus for calculating depth information on an object, using one color image, including: a selection unit adapted to select, from a plurality of color planes of the color image, at least two color planes with different image formation positions; an adjusting unit adapted to adjust a luminance difference between the selected color planes; and a calculation unit adapted to calculate the depth information using a difference in blur between the adjusted color planes.

Another aspect of the present invention provides a depth measurement method executed by a depth measurement apparatus calculating depth information on an object, using one color image, including: a selection step of selecting, from a plurality of color planes of the color image, at least two color planes with different image formation positions; an adjusting step of adjusting a luminance difference between the selected color planes; and a calculation step of calculating the depth information, using a difference in blur between the adjusted color planes.

The depth measurement method according to the aspect of the present invention enables quick depth measurement to be performed on one color image taken using a normal imaging optical system.

Further features of the present invention will become apparent from the following description of exemplary embodiments with reference to the attached drawings.

### BRIEF DESCRIPTION OF THE DRAWINGS

FIG. 1 is a diagram depicting a configuration of an imaging apparatus according to a first embodiment;

FIG. 2 is a flowchart illustrating a flow of a depth measurement process in the first embodiment;

FIG. 3 is a flowchart illustrating a flow of a brightness measurement process in the first embodiment;

FIG. 4 is a flowchart illustrating a flow of a depth map generation process in the first embodiment;

FIG. 5 is a flowchart illustrating a flow of a depth map generation process in a second embodiment;

FIG. 6 is a flowchart illustrating a flow of a depth map generation process in a third embodiment; and

FIG. 7 is a flowchart illustrating a depth measurement process in a fourth embodiment.

### DESCRIPTION OF THE EMBODIMENTS

### First Embodiment

### <System Configuration>

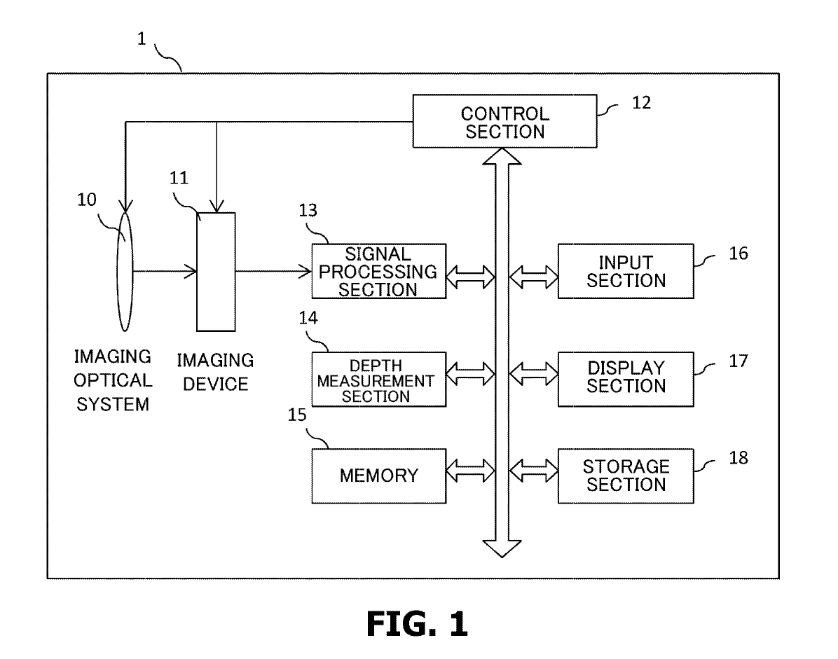

FIG. 1 is a system configuration diagram of an imaging apparatus according to a first embodiment of the present invention. An imaging apparatus 1 has an imaging optical system 10, an imaging device 11, a control section 12, a signal processing section 13, a depth measurement section 14, a memory 15, an input section 16, a display section 17, and a storage section 18.

The imaging optical system 10 is an optical system including a plurality of lenses to form incident light into an image on an image plane in the imaging device 11. In the present embodiment, the imaging optical system 10 is an optical system with a variable focus and enables automatic focusing using an autofocus function of the control section 12. An autofocus scheme may be passive or active.

The imaging device 11 is an imaging device with a CCD or a CMOS and acquires color images. The imaging device 11 may be an imaging device with a color filter or an imaging device with three CCDs for different colors. The imaging device 11 of the present embodiment acquires color images in three colors, R, G, and B but may be an imaging device that acquires color images in more than three colors including invisible wavelength.

The control section 12 is a functional unit to control the sections of the imaging apparatus 1. Examples of the functions of the control section 12 include autofocus (AF), change in focus position, change in F value (aperture), image capturing, control of a shutter and a flash (neither of which is depicted in the figures), and control of the input section 16, the display section 17, and the storage section 18.

The signal processing section 13 is a unit that processes signals output from the imaging device 11. Specific functions of the signal processing section 13 include A/D conversion and noise removal for analog signals, demosaicing, brightness signal conversion, aberration correction, white balance adjustment, and color correction. Digital image data output from the signal processing section 13 is temporarily accumulated in the memory 15. The data is displayed on the display section 17, stored (saved) in the storage section 18, or output to the depth measurement section 14 and then objected to desired processing.

The depth measurement section 14 is a functional section that calculates information on a depth (distance) to an object (object) in one obtained color image in a depth direction utilizing a difference in image forming position associated with a color (wavelength). The depth measurement section 14 selects two different color planes from one color image and calculates depth information using a difference in blur between the two color planes. Detailed operations of depth measurement will be described below.

The input section 16 is an interface operated by a user to input information to the imaging apparatus 1 and to change settings for the imaging apparatus 1. For example, dials, buttons, switches, or a touch panel may be utilized as the input section 16.

The display section 17 is a display unit provided by a liquid crystal display or an organic EL display. The display section 17 is utilized, for example, to check a composition at the time of image taking, to browse taken or recorded images, and to display various setting screens and message information.

The storage section 18 is a nonvolatile storage medium in which data on taken images and parameter data utilized for the imaging apparatus 1 are stored. As the storage section 18, a storage medium of large capacity is preferably used on which read operations and write operations can be quickly performed. For example, a flash memory may be suitably used.

<Method for Measuring the Object Depth>

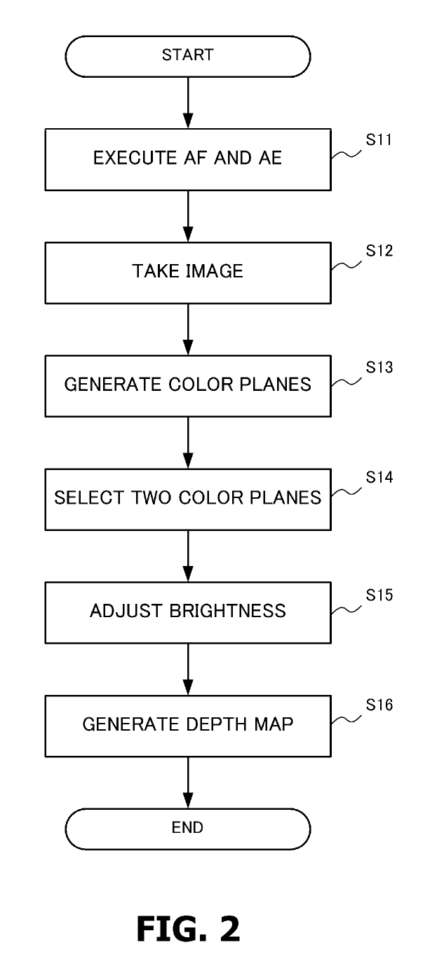

Now, a depth measurement process executed by the imaging apparatus 1 will be described in detail with reference to FIG. 2 that is a flowchart illustrating a flow of processing.

When a user operates the input section 16 to instruct the apparatus to perform depth measurement and starts image taking, autofocus (AF) and automatic exposure control (AE) are performed to determine a focus position and an aperture (F number) (step S11). Then, in step S12, image taking is performed, and the imaging device 11 captures an image.

In step S13, the signal processing section 13 generates a plurality of color planes corresponding to color filters from a taken image such that the resultant image is suitable for depth measurement, and temporarily accumulates the color planes in the memory 15. For example, when the taken image is a color image in a Bayer array, pixels of the same color filter are extracted to generate four color planes. Specific data formats for color images and color planes are not particularly limited. In this case, two green planes (G planes) may be integrated together or one of the two green planes may be selected, to obtain three color planes in R, G, and B. Alternatively, RGB color planes may be utilized which are generated by a demosaicing process. In color planes generated by the demosaicing process, a difference in brightness associated with the transmittance of the color filter and white balance are adjusted. On the other hand, a difference in brightness associated with the transmittance of the color filter remains in a color plane generated by image extraction.

Steps S14 to S16 are processing executed by the depth measurement section 14. First, in step S14, two color planes utilized for depth measurement are selected from a plurality of color planes in one color image. At this time, the selection is performed using, as indicators, a difference in image formation position (axial chromatic aberration) pre-obtained by measurement or the magnitudes of axial chromatic aberrations obtained from optical design data. The transmission wavelength of the color filter has a certain wavelength width, and thus, an image formation position in each color plane is a composition of image forming positions of optical images with wavelengths passing through the color filter. The image formation position further depends on the spectral reflectance of the object. Thus, in comparison of image formation positions, axial chromatic aberrations are preferably evaluated using a difference in image formation position between optical images with typical wavelengths such as a wavelength with the highest transmittance or a central wavelength in the color filter. Alternatively, the wavelengths in the color filter may be weighted according to the transmittance to obtain an average value (the wavelength of the color filter), and the image formation position of an optical image with that wavelength may be used to evaluate axial chromatic aberrations.

Methods for selecting color planes taking axial chromatic aberrations into account will be described. One of the methods involves selecting two colors with significant axial chromatic aberrations on color planes. This is because, although axial chromatic aberrations are suppressed in an imaging optical system used for common cameras, a significant difference in image formation position is preferable when the DFD is used. An alternative method is to select a color plane for which the color filter has a high transmittance and a wavelength close to the design wavelength of the optical system and a color plane that is most different from the above-described color plane in image formation position. For example, when three color planes in R, G, and B are obtained from a taken image, in general it is suitable to use, as a reference plane, a G plane for which the color filter has a high transmittance and a wavelength close to the design wavelength of the optical system. Then, one of the red and blue planes (R and B planes) that is more different from the G plane in image formation position is selected as the other color plane. For a zoom lens, colors with significant axial chromatic aberrations may vary according to a focal distance based on optical design. Thus, information on axial chromatic aberration or selected color plane information is held for each focal distance to allow selection of color planes corresponding to the focal distance at the time of image taking.

A difference in image formation position between two images needed when depth measurement is performed using the DFD is approximately 20 to 30 μm if each pixel in the imaging device is approximately 2 μm in size and the F number is 4. Such a difference in image formation position between the color planes may be caused by an axial chromatic aberration in a common compact digital camera. Hence, depth measurement can be achieved without the need for an optical design that allows a significant axial chromatic aberration to occur.

In step S15, for the color planes generated in step S13, a difference in brightness between the color planes resulting from a difference in the transmittance of the color filter or the spectral reflectance of the object is adjusted. When, in step S13, the color planes are generated by extracting each color from the Bayer array, both of the following remain in the color planes: difference in brightness value resulting from a difference in the transmittance of the color filter and a difference in brightness associated with the spectral reflectance of the object. On the other hand, when the color planes are generated by a demosaicing process, the transmittance of the color filter and the white balance are corrected, and a difference in brightness associated with the spectral reflectance of the object remains in the color planes. When the brightness value varies between the color planes, the amount of light shot noise varies, preventing detection of only changes caused by blurs. Thus, an error occurs in measured depth. Hence, the difference in brightness value resulting from the difference in the transmittance of the color filter or the spectral reflectance needs to be adjusted.

When color planes with the transmittances of the color filters not corrected are input, first, the brightness is adjusted using the transmittances of the color filters. An adjusting method involves calculating the ratio of the transmittances of the color filters for the selected two color planes and multiplying the ratio by a ratio calculated for one of the color planes (color plane corresponding to the denominator of the transmittance ratio). At this time, it is suitable to use the color plane with the higher transmittance as a reference to calculate the ratio of the transmittance of the other color plane to the transmittance of the reference color plane, and to multiply the transmittance of the color plane with a low transmittance by the resultant ratio. For example, when the G plane and the R plane are selected from the R, G, and B planes, if the transmittance Tg of the G filter is higher than the transmittance Tr of the R filter (Tg>Tr), the brightness of the R plane Ir is adjusted as in Expression 1.

$${Ir}^{′} = Ir \times \frac{Tg}{Tr} \qquad [ Expression 1 ]$$

On the other hand, for color planes corrected based on the transmittance of the color filter or color planes generated by the demosaicing process, the difference in brightness value is corrected based on the spectral reflectance of the object.

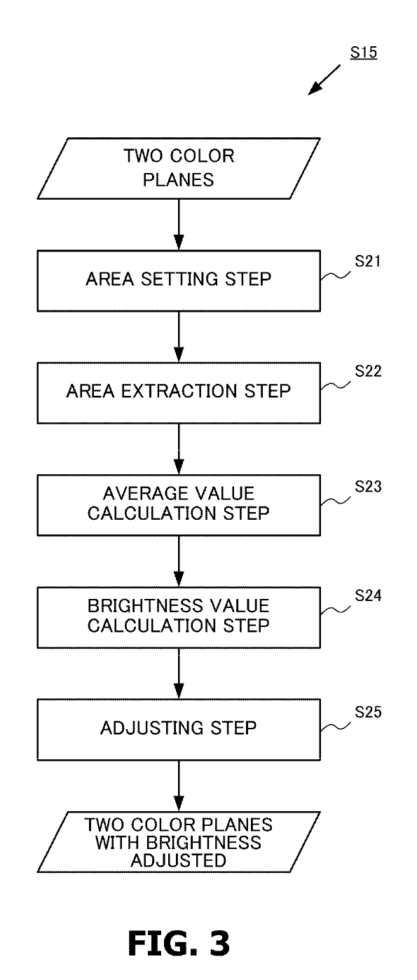

The spectral reflectance is corrected for each local area. Although objects with different spectral reflectances may be present in the selected local area, it is assumed that a single object having a uniform spectral reflectance is present in the local area. As a result, it may be expected that a difference in brightness variation between the color planes in the local area results from a difference in blur and that a difference in the average of the brightness results simply from a difference in spectral reflectance within the same object. FIG. 3 is a flowchart of brightness adjustment.

First, in an area setting step S21, a local area is set in the color planes. In an area extraction step S22, a local area image is extracted from each of the two color planes. Then, in an average value calculation step 23, the average value of the brightness is calculated for the selected two local areas. In an adjustment value calculation step 24, the ratio of two average values is determined to calculate an adjustment value. Finally, in an adjusting step S25, the color plane used as a denominator in the adjustment value calculation step S24 is multiplied by the calculated adjustment value to adjust the brightness.

A low spectral reflectance leads to small values for the color plane and thus an insignificant change in brightness resulting from blur. However, adjustment can be achieved by using the above-described brightness adjusting process to increase the brightness value, allowing standardization of a change in brightness between two images caused by blur. That is, the adverse effect of a difference in spectral reflectance can be excluded.

When the local area images in the two color planes are represented as I1 and I2 and the brightness of the central position (x,y) of I1 is adjusted, the central position (x, y) of an image I1′ with the brightness adjusted is expressed by Expression 2.

$$I {1}^{′} ( x , y ) = \frac{Σ I 2}{Σ I 1} \times I 1 ( x , y ) \qquad [ Expression 2 ]$$

The adjustment may be executed so as to increase the brightness value of the color plane with a lower brightness. Increasing the adjustment value makes noise in the image more significant. However, the adverse effect of the noise can be suppressed by performing filtering that cuts high frequencies in a band limitation step in a depth map generation process.

When color planes are input in which a difference in brightness associated with the transmittance of the color filter remains, the correction process based on the transmittance of the color filter (Expression 1) may be omitted, and the correction process based on the brightness average value in the local area (Expression 2) may be exclusively executed. This is because the difference in brightness associated with the transmittance of the color filter is reflected in the average value, enabling simultaneous corrections.

The above-described process is executed all over the image to obtain two color planes with the brightness adjusted.

In step S16, a depth map is calculated using the two color planes with the brightness adjusted. The depth map is data indicative of the distribution of an object depth within a taken image. The object depth may be a distance from the imaging apparatus to the object or a relative distance from a focus position to the object. The object depth may be an object distance or an image distance. Moreover, the magnitude or correlation amount itself of blur may be used as information indicative of the object depth. The distribution of the calculated object depth is displayed through the display section 17 and saved to a recording section 19.

Although the case has been described where the brightness adjustment is performed in step S15, step S15 may be omitted and the brightness adjustment may be performed during the depth map generation in step S16. In this case, after the extraction of the local areas, steps S23 to S25 are executed to adjust the brightness of the local areas, and then, a correlation calculation is carried out to calculate a depth dependent value.

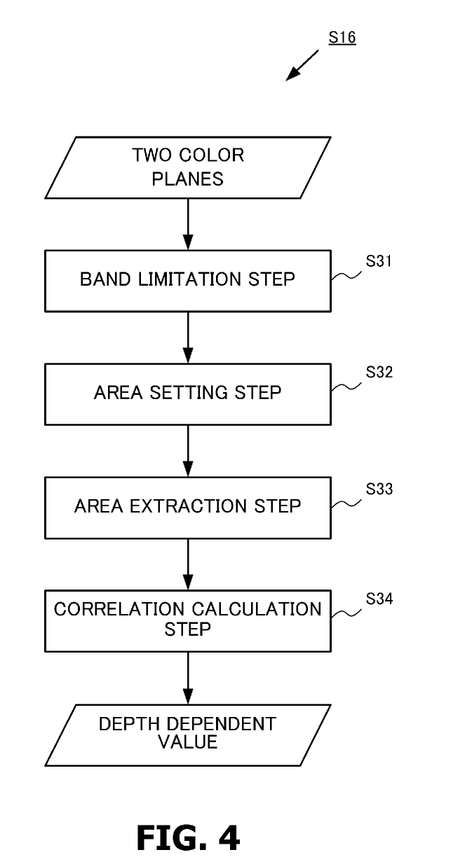

Now, the process of generating a depth map which is executed in step S16 (hereinafter referred to as a depth map generation process) will be described. In step S16, the DFD is used in which the depth is calculated using two images with different image formation positions based on the manner of blurring. FIG. 4 is a flowchart illustrating a flow of the depth map generation process in the first embodiment.

When two color planes are input, then in the band limitation step S31, the color planes are passed through a spatial frequency band utilized for depth measurement, with other spatial frequency bands removed. Since a change in blur varies according to space frequency, only the frequency band of interest is extracted in the band limitation step S31 in order to achieve stable depth measurement. The extraction of the spatial frequency band may be performed by conversion into a frequency space or by filtering, and the technique is not limited. As a passband, low to medium frequencies may be used because a high frequency band is susceptible to noise.

Then, in an area setting step S32, local areas at the same coordinate position in the input two color planes are set for the color planes with the spatial frequency band limited. A depth image (depth map) for the entire input image can be calculated by shifting the pixels one by one to set the local area all over the image and executing the following processing. The depth map need not necessarily have the same number of pixels as that in the input image and may be calculated for each pixel in the input image. The setting of the local area may be performed on pre-designated one or more areas or designated by the user via the input section 16.

In an area extraction step S33, the local areas set in the area setting step 32 are extracted from the first color plane and the second color plane.

Then, in a correlation calculation step S34, a correlation value CC for the extracted local area I1 of the first color plane and the extracted local area I2 of the second color plane is calculated in accordance with Expression 3.

$${CC}_{j} = \frac{\sum ( {I}_{1 , i} - {\overline{I}}_{1} ) ( {I}_{2 , i} - {\overline{I}}_{2} )}{max [ \sum {( {I}_{1 , i} - {\overline{I}}_{1} )}^{2} , \sum {( {I}_{2 , i} - {\overline{I}}_{2} )}^{2} ]} \qquad [ Expression 3 ]$$

If two color planes with different image formation positions are present, a position with an equivalent magnitude of blur is present between the image formation positions for the two colors on the image planes, and the correlation has the largest value at that position. The position is substantially intermediate between the image formation positions for the two colors, but the peak of the correlation appears at a position slightly away from the intermediate position due to a difference in defocusing associated with color. As the depth from the position of the peak of the correlation increases, the manner of blurring of the two colors changes to reduce the correlation. In other words, the level of correlation decreases as the depth from the peak position with the same blur increases in opposite directions. The correlation value varies according to the magnitude of blur resulting from defocusing. Thus, determining the correlation value allows the corresponding defocus amount to be known, enabling the relative depth to be calculated.

The obtained correlation value may be directly output and utilized as depth information or output as a relative depth from the focus position of the reference wavelength on the image plane. When the relative depth on the image plane is calculated, a conversion table or a conversion expression for the combination of the selected colors needs to be held because the characteristics of the correlation value varies according to the selected colors. Furthermore, the relative position varies according to the F number, and thus, conversion tables for the respective combinations of the selected colors and the F numbers need to be provided to allow conversions into relative depths from the focus positions on the image planes. Alternatively, a conversion expression needs to be prepared as a function dependent on the F number. Moreover, the obtained relative depth may be converted into an object depth using the focal distance and the focus depth on the object side and then be outputted.

The present embodiment has been described taking Expression 3 as an example of the calculation method. However, the calculation method is not limited to this expression and any expression may be used as long as the expression allows the blur relation between two color planes to be determined. Conversions into relative depths can be performed provided that the relation between the output value in accordance with to the calculation and the focus position on the image plane is known.

Another calculation example is Expression 4.

$${G}_{j} = \frac{\sum ( {I}_{1 , i} - {\overline{I}}_{2 , i} )}{\sum ( {∇}^{2} {I}_{1 , i} + {∇}^{2} {I}_{2 , i} )} \qquad [ Expression 4 ]$$

As a depth calculation based on Fourier transformation and using evaluative values for the frequency space, Expression 5 may be used.

$${D}_{j} = \frac{F ( {I}_{1} )}{F ( {I}_{2} )} = \frac{{OTF}_{1} \cdot S}{{OTF}_{2} \cdot S} = \frac{{OTF}_{1}}{{OTF}_{2}} \qquad [ Expression 5 ]$$

In Expression 5, F represents a Fourier transformation, OTF an optical transfer function, and S the result of the Fourier transformation for an imaged scene. Expression 5 provides the ratio of the optical transfer functions under two imaging conditions to allow a change in this value resulting from defocusing to be pre-known based on design data on the optical system, enabling conversions into the relative depths.

The present embodiment enables the depth information to be calculated by selecting two color planes with different image formation positions from one taken color image and executing a correlative calculation to detect a change in blur. This prevents possible misalignment resulting from camera shake or movement of the object when two images are acquired with the focus changed, enabling the depth information to be calculated without the need for an alignment process involving a high calculation load. Furthermore, the depth measurement accuracy can be enhanced by adjusting a difference in transmittance between the color filters. Moreover, stable depth measurement can be achieved regardless of the spectral reflectance of the object by adjusting the brightness of the two color planes using the brightness average of the local areas.

Axial chromatic aberrations need not be intentionally caused to occur, and depth measurement can be achieved even using residual axial chromatic aberrations as long as the value for the axial chromatic aberrations is known. Thus, advantageously, not only the depth information but also a high-quality image for the same point of view can be acquired.

### Second Embodiment

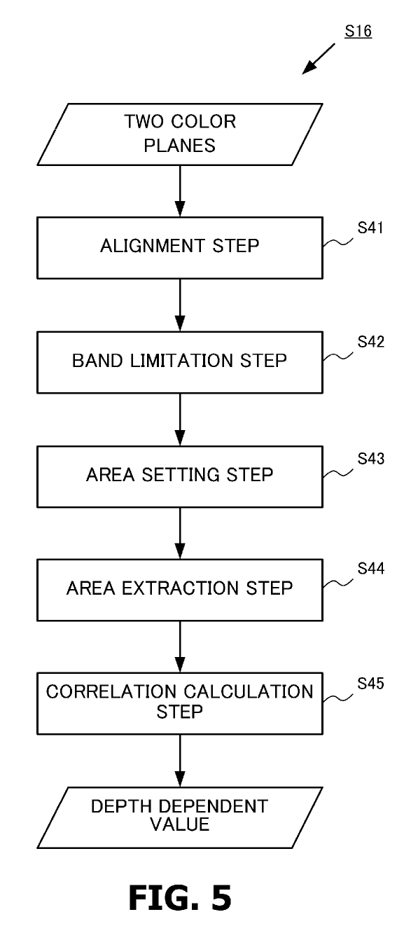

A second embodiment corresponds to the first embodiment to which an alignment process for the color planes is added. The configuration of the imaging apparatus 1 in the second embodiment is similar to the configuration of the imaging apparatus 1 in the first embodiment. The depth measurement process in the second embodiment is also similar to the depth measurement process in the first embodiment except for the depth map generation process S16. The depth map generation process S16, which is a difference from the first embodiment, will be described below. FIG. 5 is a flowchart illustrating a flow of the depth map generation process S16 in the second embodiment.

Upon receiving an image, the depth measurement section 14 executes, in step S41, a process of eliminating misalignment between two color planes caused by lateral chromatic aberrations (hereinafter referred to as an alignment process). The size of an image differs between the color planes due to the chromatic aberration of magnification. Thus, at a position with a very large image height, the object in the local area may be misaligned between the color planes, preventing correct comparison of blurs. Thus, correction values (information on lateral chromatic aberration) that is pre-measured or calculated from optical design values may be held so that an enlargement/contraction process (resizing process) is executed on each color plane to correct misalignment resulting from a difference in magnification.

Processing in steps S42 to S44 is similar to the processing in steps S31 to S34 in the first embodiment and will thus not be described below.

For misalignment resulting from the use of color planes generated by selecting pixels from a Bayer array image, aligned color planes can be generated by selecting, for a demosaiced image, values for the same pixel positions.

In the present embodiment, misalignment between the color planes caused by chromatic aberration of magnification is corrected to enable more accurate depth measurement over the entire image. The alignment process in the present embodiment is a process of enlarging or contracting the entire color plane and thus does not significantly increase the amount of calculation.

### Third Embodiment

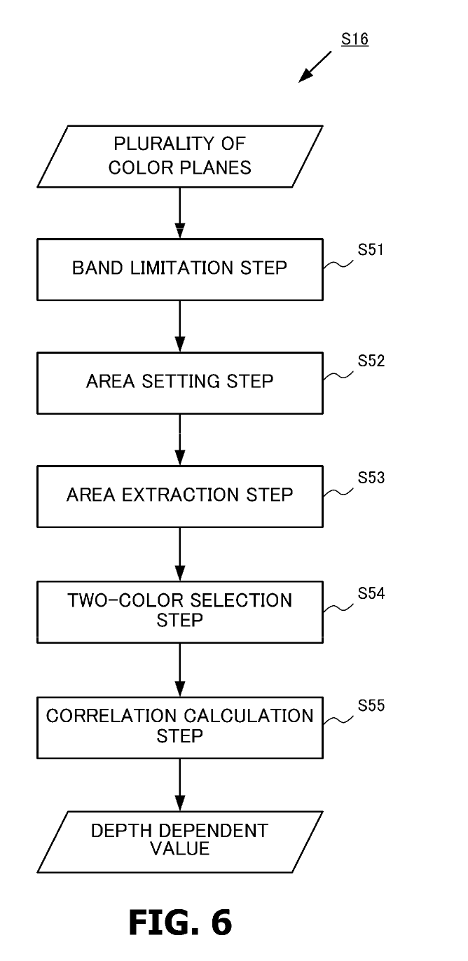

A third embodiment is an embodiment in which two color planes are selected for each local area. A configuration of the imaging apparatus 1 in the third embodiment is similar to the configuration of the imaging apparatus 1 in the first embodiment. A flow of the depth measurement process in the third embodiment is substantially similar to the flow of the depth measurement process in the first embodiment (FIG. 2) except that the selection of color planes in step S14 in the first embodiment is performed, in the third embodiment, within the depth map generation process in step S16. That is, compared to the depth measurement process in the first embodiment, the depth measurement in the third embodiment is performed, in which the processing in step S14 is omitted from the flowchart illustrated in FIG. 2 and in which the contents of the depth map generation process in step S16 are different from the contents of the depth map generation process in step S16 in the flowchart illustrated in FIG. 2. The depth map generation process S16 in the third embodiment will be described below. FIG. 6 is a flowchart illustrating a flow of the depth map generation process S16 in the third embodiment.

The depth measurement section 14 receives a plurality of color planes from which two colors are to be selected. Processing in steps S51 to S53 executed after the reception of the plurality of color planes is similar to the processing in steps S31 to S33 in the first embodiment except only for an increased number of color planes to be processed, and will thus not be described below.

Then, in step S54, color planes for two colors to be selected are determined in accordance with the brightness of each color plane in the local area. When all the color planes have significant brightness values, it is preferable to select two color planes with very different image formation positions or color planes that are very different from each other with reference to the G plane as is the case with the first embodiment. However, if the spectral reflectance varies with the object, for an object with a low reflectance for the G plane, the G plane may have a substantially small value. In such a case, even when the G plane is used for depth measurement, noise or the like precludes significant values from being obtained. Therefore, with the spectral reflectance of the object taken into account, color planes in which the brightness value of the local area of the color plane is equal to or larger than a threshold may be effectively used for depth measurement. Thus, threshold determination is performed on the brightness values, and from the color planes with a brightness value equal to or larger than the threshold, two color planes are selected which are very different from each other in image formation position. Then, step S55 is executed. For the determination of the brightness values, color planes with the spatial frequency band limited or color planes with the spatial frequency band not limited may be used. If no color plane has a brightness value equal to or larger than the threshold, it is expected that the amount of light is insufficient or the object has very low brightness. Thus, depth measurement is inhibited from being performed on this area. If only one color plane has a brightness value equal to or larger than the threshold, the object is nearly monochrome, precluding obtainment of images with different image formation positions. Consequently, depth measurement fails to be performed. As described above, when one or less color plane has a brightness value equal to or larger than the threshold, information indicative of a depth measurement disabled area is output.

The amount of misalignment or the manner of change in blur varies with the pair of color planes selected. Thus, even for objects located at the same depth, depth dependent values such as a correlation value may differ. Therefore, the relation between the depth dependent value and the depth is pre-acquired for each pair of color planes, and the adverse effect of misalignment between the image formation positions or the amount of change in blur is corrected. Then, the result is output.

In the present embodiment, even with an area with substantially low brightness for a certain color due to the spectral reflectance of the object, stable depth measurement can be performed using another color. The present embodiment is also effective for enabling detection of a low-brightness area or an area in which accurate depth measurement is precluded due to a failure to obtain a difference in image formation position when the corresponding color is close to a single wavelength.

### Fourth Embodiment

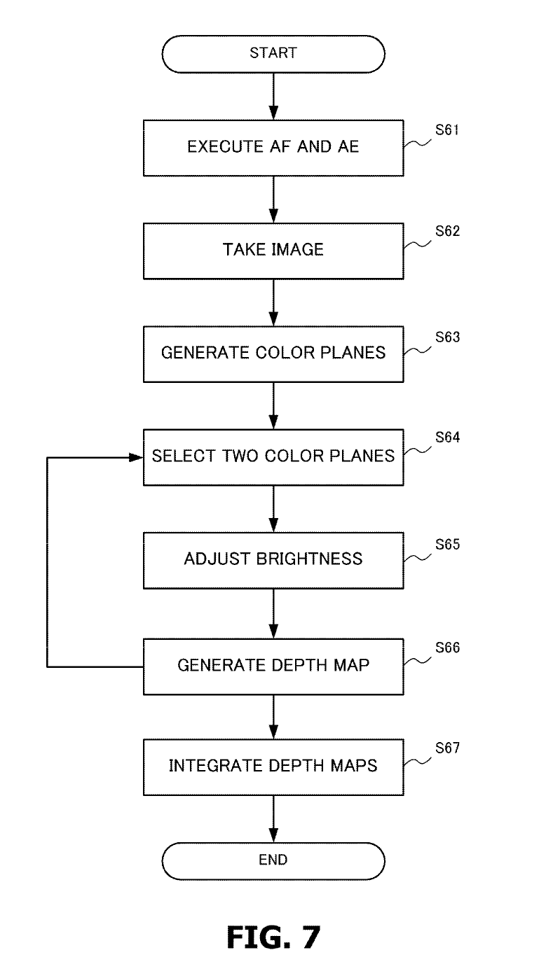

A fourth embodiment is an embodiment in which depth measurement is performed a plurality of times by changing two color planes selected. A configuration of the imaging apparatus 1 in the fourth embodiment is similar to the configuration of the imaging apparatus 1 in the first embodiment. The fourth embodiment is different from the first embodiment in the general flow of the depth measurement process. A difference from the first embodiment will be described below. FIG. 7 is a flowchart illustrating a flow of the depth measurement process in the fourth embodiment.

The difference from the first embodiment is that a plurality of combinations of two color planes is selected and that the processing in steps S64 to S66 is executed for each of the combinations. The combinations of two color planes selected may be all the combinations, a certain number of preset combinations, or a certain number of combinations that meet a predetermined condition. The number of repetitions executed may be predetermined or may be set by the user.

Processing in steps S61 to S66 is similar to the processing in steps S11 to S16 in the first embodiment (FIG. 2) except for the above-described point, and will thus not be described in detail.

A plurality of depth maps generated by repeating steps S64 to S66 is integrated together in step S67. An integration method may be optional. For each area, depths generated from color planes with the highest brightness may be selected and integrated together. Alternatively, depths may be calculated by weighted averaging according to the brightness and integrated together.

In the present embodiment, the integration process is executed using a plurality of depth maps obtained by executing depth map generation a plurality of times with a combination of two selected color planes changed. Thus, a stable depth map can be generated regardless of the spectral distribution of the object.

<Variations>

The description of the embodiments is illustrative for the description of the present invention. The present invention may be implemented by changing or combining the embodiments together as needed without departing from the spirits of the invention. For example, the present invention may be implemented as an imaging apparatus including at least a part of the above-described process or a depth measurement apparatus with no imaging unit. Alternatively, the present invention may be implemented as a depth measurement method or as an image processing program that allows a depth measurement apparatus to execute the depth measurement method. The above-described processes and units may be freely combined together for implementation unless the combination leads to technical inconsistency.

Alternatively, the element techniques described in the embodiments may be optionally combined together. For example, it is preferable to adopt one or both of the brightness adjustment process described in the first embodiment and the misalignment correction process described in the second embodiment.

### Implementation Examples

The above-described depth measurement technique of the present invention can preferably be applied to, for example, an imaging apparatus such as a digital camera or a digital camcorder or an image processing apparatus or a computer that executes image processing on image data obtained by the imaging apparatus. Furthermore, the present invention can be applied to various types of electronic equipment (including a cellular phone, a smartphone, a slate terminal, and a personal computer) incorporating such an imaging apparatus or an image processing apparatus.

In the description of the embodiments, the configuration in which the depth measurement function is incorporated into the imaging apparatus main body is illustrated. However, depth measurement may be performed by an apparatus other than the imaging apparatus. For example, the depth measurement function may be incorporated into a computer with an imaging apparatus so that an image taken by the imaging apparatus is acquired by the computer, which then calculates the depth. Alternatively, the depth measurement function may be incorporated into a computer that is accessible on the network by wire or wirelessly so that the computer acquires a plurality of images via a network to perform depth measurement.

The obtained depth information may be utilized for various types of image processing, for example, image area division, generation of three-dimensional images or depth images, and emulation of a blurring effect.

Specific implementation in the above-described apparatus may be achieved using either software (program) or hardware. For example, a program may be stored in a memory in a computer (microcomputer, FPGA, or the like) built into an imaging apparatus or an image processing apparatus and executed by the computer to implement various processes to accomplish the object of the present invention. Alternatively, a dedicated processor such as ASIC is preferably provided which implements all or a part of the processing of the present invention using a logical circuit.

To accomplish this object, the program is provided to the computer, for example, through a network or via various types of recording media that may provide the above-described storage apparatuses (in other words, computer readable recording media holding data in a non-transitory manner). Therefore, the scope of the present invention includes all of the above-described computer (including a device such as CPU or MPU), the above-described method, the above-described program (including a program code and program product), and the computer readable recording medium holding the program in a non-transitory manner.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-188101, filed on Sep. 16, 2014, which is hereby incorporated by reference herein in its entirety.

What is claimed is:

1. A depth measurement apparatus for calculating depth information on an object, using one color image,
the depth measurement apparatus comprising:
a selection unit adapted to select, from a plurality of color planes of the color image, at least two color planes with different image formation positions;
an adjusting unit adapted to adjust a luminance difference between the selected color planes; and
a calculation unit adapted to calculate the depth information using a difference in blur between the adjusted color planes.

2. The depth measurement apparatus according to claim 1, wherein the adjusting unit is adapted to adjust the luminance difference, for each local area of the color image, based on average values of brightness values for the color planes in each local area.

3. The depth measurement apparatus according to claim 1, wherein the adjusting unit is adapted to adjust the luminance difference, based on a ratio of transmittances of color filters for the selected color planes.

4. The depth measurement apparatus according to claim 1, further comprising a correction unit adapted to correct misalignment between the selected two color planes,
wherein the calculation unit is adapted to calculate the depth information, based on the color planes for which the luminance difference and the misalignment have been corrected.

5. The depth measurement apparatus according to claim 4, wherein the correction unit is adapted to execute a resizing process on one of the color planes using information on lateral chromatic aberration of an imaging optical system, in order to correct misalignment based on lateral chromatic aberration.

6. The depth measurement apparatus according to claim 1, wherein the selection unit is adapted to use information on axial chromatic aberration in an imaging optical system to select, from among the plurality of color planes, two color planes which differ most from each other in image formation position.

7. The depth measurement apparatus according to claim 1, wherein the selection unit is adapted to hold a table containing color planes on which selection is performed for each focal distance of an imaging optical system, and to select color planes corresponding to the focal distance at a time of image taking.

8. The depth measurement apparatus according to claim 1, wherein the selection unit is adapted to select color planes for each local area of the color image, and
depth information is calculated for each local area, based on the selected color planes.

9. The depth measurement apparatus according to claim 1, wherein
the color image comprises three or more color planes,
the selection unit is adapted to select a plurality of combinations of two color planes, and
the calculation unit is adapted to calculate a plurality of pieces of depth information based on the color planes in each of the plurality of combinations, and to integrate the plurality of pieces of depth information together in order to output the integrated depth information.

10. An imaging apparatus comprising:
an imaging optical system;
an imaging device that acquires a color image formed of a plurality of color planes; and
the depth measurement apparatus for calculating depth information on an object, using one color image,
wherein the depth measurement apparatus comprises:
a selection unit adapted to select, from a plurality of color planes of the color image, at least two color planes with different image formation positions;
an adjusting unit adapted to adjust a luminance difference between the selected color planes; and
a calculation unit adapted to calculate the depth information using a difference in blur between the color planes for which the luminance difference has been adjusted.

11. A depth measurement method executed by a depth measurement apparatus calculating depth information on an object, using one color image,
the depth measurement method comprising:
a selection step of selecting, from a plurality of color planes of the color image, at least two color planes with different image formation positions;
an adjusting step of adjusting a luminance difference between the selected color planes; and
a calculation step of calculating the depth information, using a difference in blur between the adjusted color planes.

12. The depth measurement method according to claim 11, wherein the adjusting step adjusts the luminance difference, for each local area of the color image, based on average values of brightness values for the color planes in each local area.

13. The depth measurement method according to claim 11, wherein the adjusting step adjusts the luminance difference, based on a ratio of transmittances of color filters for the selected color planes.

14. The depth measurement method according to claim 11, further comprising a correction step of correcting misalignment between the selected two color planes,
wherein the calculation step calculates the depth information, based on the color planes for which the luminance difference and the misalignment have been corrected.

15. The depth measurement method according to claim 14, wherein the correction step executes a resizing process on one of the color planes, using information on lateral chromatic aberration in an imaging optical system, in order to correct the misalignment, based on lateral chromatic aberration.

16. The depth measurement method according to claim 11, wherein the selection step uses information on axial chromatic aberration of an imaging optical system to select, from among the plurality of color planes, two color planes which differ most from each other in image formation position.

17. The depth measurement method according to claim 11, wherein the selection step references a table containing color planes on which selection is performed for each focal distance of an imaging optical system, to select color planes corresponding to the focal distance at a time of image taking.

18. The depth measurement method according to claim 11, wherein the selection step selects color planes for each local area of the color image, and
depth information is calculated for each local area, based on the selected color planes.

19. The depth measurement method according to claim 11, wherein
the color image is formed of three color planes,
the selection step selects a plurality of combinations of two color planes, and
the calculation step calculates a plurality of pieces of depth information, based on the color planes in each of the plurality of combinations and integrates the plurality of pieces of depth information together in order to output the integrated depth information.

20. A computer readable storage medium including a program stored therein in a non-transitory manner, the program allowing a computer to execute a depth measurement method, wherein the depth measurement method comprises:
a selection step of selecting, from a plurality of color planes of the color image, at least two color planes with different image formation positions;
an adjusting step of adjusting a luminance difference between the selected color planes; and
a calculation step of calculating the depth information, using a difference in blur between the color planes for which the luminance difference has been adjusted.
